(19) United States
(12) Patent Application Publication
(10) Pub. No.: US 2014/0153388 A1
(43) Pub. Date: Jun. 5, 2014

(54) RATE LIMIT MANAGERS TO ASSIGN NETWORK TRAFFIC FLOWS

(71) Applicant: HEWLETT-PACKARD DEVELOPMENT COMPAN, Houston, TX (US)

(72) Inventors: Kevin C. Webb, San Diego, CA (US); Praveen Yalagandula, San Francisco, CA (US); Jean Tourrilhes, Mountain View, CA (US); Sujata Banerjee, Palo Alto, CA (US); Jeffrey C. Mogul, Menlo Park, CA (US); Puneet Sharma, Palo Alto, CA (US)

(73) Assignee: HEWLETT-PACKARD DEVELOPMENT COMPANY, L.P., Houston, TX (US)

(21) Appl. No.: 13/690,426

(22) Filed: Nov. 30, 2012

(51) Int. Cl. H04L 12/56

(52) U.S. Cl. CPC H04L 47/25
USPC 370/230

(57) ABSTRACT

A rate limit manager is to assign network traffic flows to hardware rate limiters. The network traffic flows are associated with rate limit values. The rate limit manager determines threshold values to assign flow(s) to hardware rate limiters, and the rate limit manager is to assign flow(s) to a last remaining unassigned hardware rate limiter independent of the threshold value.

### BACKGROUND

In a shared network environment, such as a data center network or other network, multiple tenants may be offered the use of network bandwidth. There may be links in the network whose available bandwidth is insufficient to accommodate the offered load from all tenants. Rate limiting may provide network operators with control over tenant traffic, to enable tenants to use a share of network bandwidth resources. Although hardware-based rate limiters may be used, they are a relatively scarce resource in commodity network devices. In general, there may be more tenants than available hardware rate limiters, leading to a resource management problem. Rate limiting may be performed in end host software, but the software approach may raise efficiency issues and a need for end host machines to be specifically configured to consume additional resources, e.g., by needing to run a trusted hypervisor.

### BRIEF DESCRIPTION OF THE DRAWINGS/FIGURES

FIG. 1 is a block diagram of a system including a rate limit manager according to an example.

FIG. 2 is a block diagram of a system including a rate limit manager according to an example.

FIG. 3 is a block diagram of a system including a rate limit manager according to an example.

FIG. 4 is a flow chart based on assigning flows according to an example.

FIG. 5 is a flow chart based on selecting flows to be assigned according to an example.

FIG. 6 is a flow chart based on assigning flows according to an example.

### DETAILED DESCRIPTION

A network device, such as a commodity network switch, may have a small, fixed number of hardware rate limiters to rate-limit traffic of various tenants. For example, in a multi-tenant data center network, each tenant's traffic (e.g., flows associated with that tenant) may be rate limited at each edge switch. In such an environment, at e.g., a network switch, there may be traffic from many more tenants than there are available hardware rate limiters on that switch. Thus, examples provided herein enable effective multiplexing of multiple tenants across a set of hardware rate limiting resources, enabling hardware rate limiters of even resource-constrained network devices to service multiple tenants effectively. Examples provided herein may facilitate a rate limiting presence inside a network, without requiring modifications to end host hardware or software, and without making assumptions of trusted host behavior.

In an example, a rate limit manager is to assign network traffic flows to hardware rate limiters. The hardware rate limiters are to enforce rate limits of the network traffic flows. Each of the network traffic flows may be associated with a corresponding rate limit value. The rate limit manager is to determine, for an unassigned hardware rate limiter, a threshold value, and assign at least one flow to the unassigned hardware rate limiter based on the threshold value. The rate limit manager is to assign, to a last remaining unassigned hardware rate limiter, the remaining unassigned flows, independent of the threshold value.

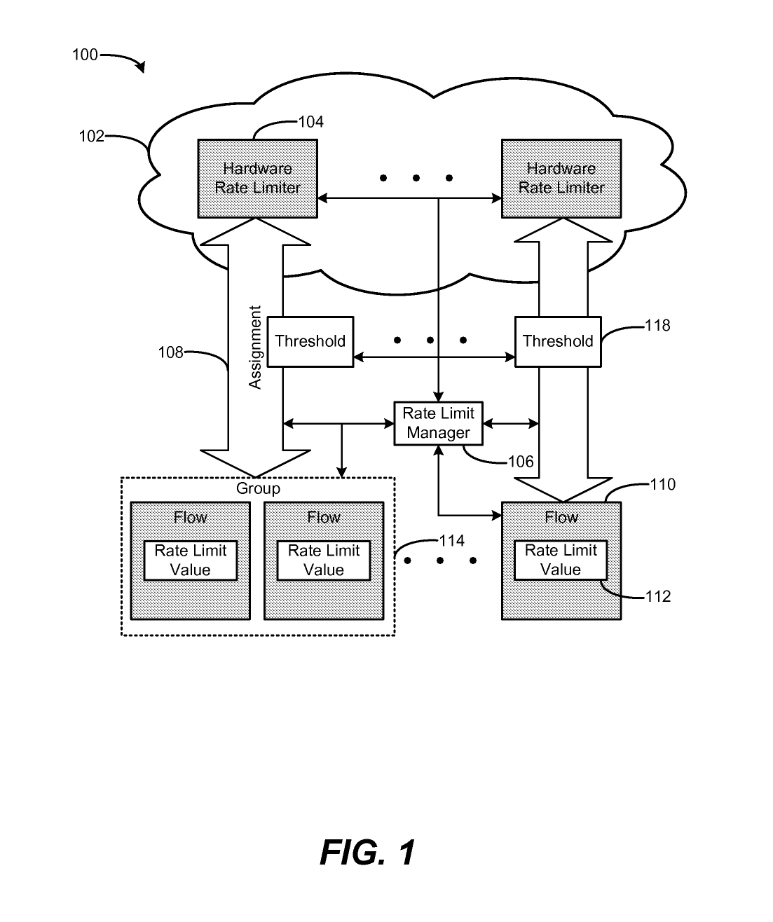

FIG. 1 is a block diagram of a system 100 including a rate limit manager 106 according to an example. The rate limit manager 106 may interact with a plurality of hardware rate limiters 104 of a network 102. The rate limit manager 106 is to determine threshold 118 for assigning a flow 110 to a hardware rate limiter 104, based on assignment 108. The flow 110 may include a rate limit value 112, and flows 110 may be assigned to a group 114.

By assigning the flows 110 to the hardware rate limiters 104, a network (e.g., data center network) may be shared among multiple tenants and their flows 110. For example, the slowest corresponding tenants/flows 110 may share a hardware rate limiter 104, freeing up other hardware rate limiters 104 for tenants having higher network bandwidth needs. Thus, hardware rate limiters 104 may perform bandwidth rate limiting, even when there are a limited number of the hardware rate limiters 104 available on the network 102 (e.g., in commodity switches of the network 102; the network 102 may itself represent a hardware component such as a switch). If there are more tenants/flows 110 than the available hardware rate limiters 104, the rate limit manager 106 may use the limited number of available hardware rate limiters 104 while still providing network performance guarantees for those tenants/flows 110, e.g., enabling a tenant/flow 110 to get a usable share of the network bandwidth.

The rate limit manager 106 may compute rate limits for the hardware rate limiters 104. For example, the rate limit manager 106 may determine the threshold 118, and assign flows 110 to a hardware rate limiter 104 based on the threshold 118. The rate limit manager 106 also may determine groups 114 of multiple flows 110 to be assigned to a hardware rate limiter 104. The rate limit manager 106 may be implemented as hardware and/or as software (e.g., according to instructions from a computer readable medium).

The hardware rate limiters 104 of network 102 may be in a device (discrete hardware, such as a network switch for example) and may be configured by the rate limit manager 106 to receive assignments 108 of flows 110. Network 102 may represent a collection of hardware rate limiters 104, and those hardware rate limiters 104 may be resident in different types of hardware throughout the network 102. Hardware rate limiters 104 may be among tens of thousands of hardware rate limiters 104 per switch, or fewer, depending on implementation of the network switch. An example switch may be limited to 256 hardware rate limiters 104, while another example switch may employ 16,000 hardware rate limiters 104, for example.

A flow 110 may be associated with a tenant seeking to use the services of the network 102. For example, a tenant may use a cloud data center as the network 102, and the network 102 may provide virtual datacenter services to the tenant. Thus, a large number of different tenants (i.e., customers) may utilize the cloud services/network 102, and a tenant may be considered a customer whose network activity is to be isolated from that of other tenants. The network 102 may be, for example, a public cloud, such as HP cloud services, Amazon Elastic Compute Cloud (Amazon EC2), or other services/networks 102. Thus, tenants may include different enterprises and/or parties using that public cloud/network 102. The network 102 may be a private cloud, having different applications each running at a certain priority, having some network isolation between the different applications of the private cloud/network 102. Example systems are applicable to different types of clouds/networks 102, and the term tenant may be used herein to mean a unit to be provided isolation support on the network 102. In an example network environment providing a plurality of applications, with each application being provided a certain rate limit, that application may be referred to as a tenant (e.g., by being provided with network isolation, the application may be deemed a tenant).

Many, e.g., hundreds of thousands, of tenants may be associated with a network zone (network 102). Economics of cloud computing may be improved by allowing as many tenants as reasonably possible to be associated with network 102. Thus, a set of tenants may share the rate limiting resources of a piece of network hardware (generally a switch; e.g., network 102). A tenant may benefit by being mapped to a unique hardware rate limiter 104 for the exclusive use of that tenant. In practice, however, there may be more tenants than hardware rate limiters 104. Examples herein enhance the ability to accommodate many tenants in view of a limited pool of hardware rate limiters 104. Techniques provided herein also enable benefits even if the number of tenants does not greatly exceed the number of hardware rate limiters 104, because techniques enable the hardware rate limiters 104 to be used more effectively compared to other less-sophisticated approaches such as first-come-first-served, random, and so on.

The system 100 may involve the transmission of network packets, e.g., to/from a tenant. A packet may be part of a flow 110, and typically may include packet headers, with information such as an internet protocol (IP) address, a transmission control protocol (TCP) address, or other information relating to the network packet. The rate limit manager 106 may determine which tenant a packet corresponds to, based on the packet header or other information. The rate limit manager 106 may direct the hardware rate limiter 104 to rate limit that packet according to the particular tenant/flow 110. Thus, the packet/flow 110 may be matched with a hardware rate limiter 104, by assigning the flow 110 to the hardware rate limiter 104 (or vice versa).

When the number of tenants/flows exceeds the number of hardware rate limiters 104, multiple tenants/flows 110 may be multiplexed across the same hardware rate limiter 104. Examples herein may intelligently manage this multiplexing, by mapping tenants/flows with similar rate limit values 112 (and/or other flow descriptors/parameters) to the same hardware rate limiter 104. For example, multiple flows 110 may be assigned as a group 114. Whether a flow 110 is part of a group 114 may be based on various factors, such as the size of the flows' corresponding rate limit values 112. Group 114 also may depend on the total bandwidth that is to be provided to all the tenants/flows 110 by the hardware rate limiter 104.

In an example, suppose there are five hardware rate limiters 104 and ten tenants/flows 110 to be assigned. Each flow 110 has a rate limit value 112 to be enforced, while isolating the traffic of the flows 110 from each other. With five available hardware rate limiters 104 in this example, it is not possible to assign a unique hardware rate limiter 104 to each of the ten tenants/flows 110, because the number of flows 110 exceeds the number of available hardware rate limiters 104. Thus, the ten flows 110 may be divided into five groups 114 corresponding to the five hardware rate limiters 104, to assign the multiple tenants/flows 110 to the hardware rate limiters 104. A group 114 may include a single flow 110 or a number of flows 110. Even when formed in a group 114, network traffic for the group 114 of flows 110 may be isolated between each flow 110.

In an example, a group 114 of three flows 110 may be rate-limited such that each flow 110 of that group 114 may receive one-third of the traffic bandwidth allocated by the group's corresponding hardware rate limiter 104. In this example, it is assumed that the assigned tenants/flows 110 will be fairly/equally sharing their corresponding hardware rate limiter 104, as enabled by the hardware rate limiter 104 (e.g., based on various transmission protocols or other hardware rate-limiting features supported by the hardware rate limiter

104). In the example of three tenants/flows 110 assigned to a hardware rate limiter 104, if a total rate-limit of 600 Mbps is imposed, each of those tenants/flows 110 may be provided with up to 200 Mbps, if all of those tenants/flows 110 attempt to utilize/send traffic at the same time under the 600 Mbps total constraint for that group 114.

Flows 110 associated with a tenant may be provided with network performance guarantees. A flow 110 may be described as a category of packets. Rate limit values 112 are applied to the flows 110. Each flow 110 may have an associated rate limit value 112, and the rate limit manager 106 may assign those flows 110 and rate limit values 112 to the hardware rate limiters 104. Each flow 110 may represent a tenant, having an indication of a rate limit value 112 corresponding to what the rate limit manager 106 has assigned to a tenant. Irrespective of where the packets of a flow 110 are coming from and where they are going, given a packet, the rate limit manager 106 may determine to which tenant/flow 110 the packet belongs, and the system 100 may rate limit that flow 110 of packets based on limits corresponding to the tenant. Thus, system 100 (e.g., rate limit manager 106) may manage traffic for tenant guarantees based on assigning flows 110 to hardware rate limiters 104.

A packet of a flow 110 may be assigned based on its rate limit value 112, and may be examined for other details, e.g., by looking at the encapsulation scheme of the packet (e.g., a tenant identifier or other flow descriptors/parameters may be included in the packet). For example, a packet of system 100 may carry a field in its header that denotes the identifier for its corresponding tenant. Even if a packet of a flow 110 does not have that specific field in its header, the rate limit manager 106 also may consider a packet's address (e.g., a source IP address and/or destination IP address), or other fields of the packet, to determine a tenant identifier for that packet/flow 110. Thus, it is possible to define a flow 110 in a flexible manner as a subset of packets whose headers match a given pattern.

Generally, the rate limit manager 106 may identify a set of flows 110 to be assigned, and available hardware rate limiters 104 (e.g., tuples of flows 110 and hardware rate limiters 104), and create groups 114 of flows 110. The rate limit manager 106 may create the groups 114/assignments 108 while satisfying different goals/restrictions (e.g., restrictions on which flows 110 may be grouped together) and optimizing different metrics (e.g., minimize the maximum difference between the rate limit value 112 of a flow 110 and the mean of the rate limit values 112 in the group 114 to which the flow 110 is to be assigned).

Additional aspects of a packet may be used to assign a flow 110. Not only the contents of a packet header, but also its data and other characteristics such as on which physical port the packet arrived, and on which physical port the packet is to depart. Embodiments of the rate limit manager 106 may examine the contents of the packet (e.g., its data), not just its header fields, to determine a flow 110 and how it is to be grouped/assigned/etc. The determining can be done by the rate limit manager 106 doing packet inspection or otherwise looking at the packets. For example, a tenant associated with music streaming may have its packets/flows 110 identified by examining the data of a packet to identify streaming music data.

The rate limit manager 106 is to manage multiple different tenants/flows 110. Given a plurality of flow descriptors that describe a flow 110, for each of those flow descriptors, a hardware rate limiter 104 may be associated. The rate limit manager 106 is to implement the given mapping of flow descriptors to rate limit values 112. A number of such mappings may exceed the number of hardware rate limiters 104 in the network 102 (e.g., in a network switch). Thus, the rate limit manager 106 may manage a multi-dimensional mapping between a plurality of flow descriptors (that may include rate limit values 112) and the hardware rate limiters 104. For example, one flow may be associated with a plurality of rate limit values 112 mapped to different flow descriptors of a flow 110 (e.g., the rate limit value 112 for a flow 110 may change according to a destination of that flow 110, and may vary from a rate limit demand predicted for a flow 110).

As a general technique that the rate limit manager 106 may employ, if a number of flows 110 to be assigned is equal to or less than a number of hardware rate limiters 104, then the rate limit manager 106 may assign each of those flows 110 to a separate hardware rate limiter 104. If there is a change (e.g., additional flows 110 are introduced), or if the number of flows 110 otherwise exceeds the number of hardware rate limiters 104, the rate limit manager 106 may re-evaluate and re-assign the flows 110 to accommodate the change/difference. The rate limit manager 106 may dynamically re-evaluate the situation on-the-fly to monitor for changes, and re-assign accordingly as-needed.

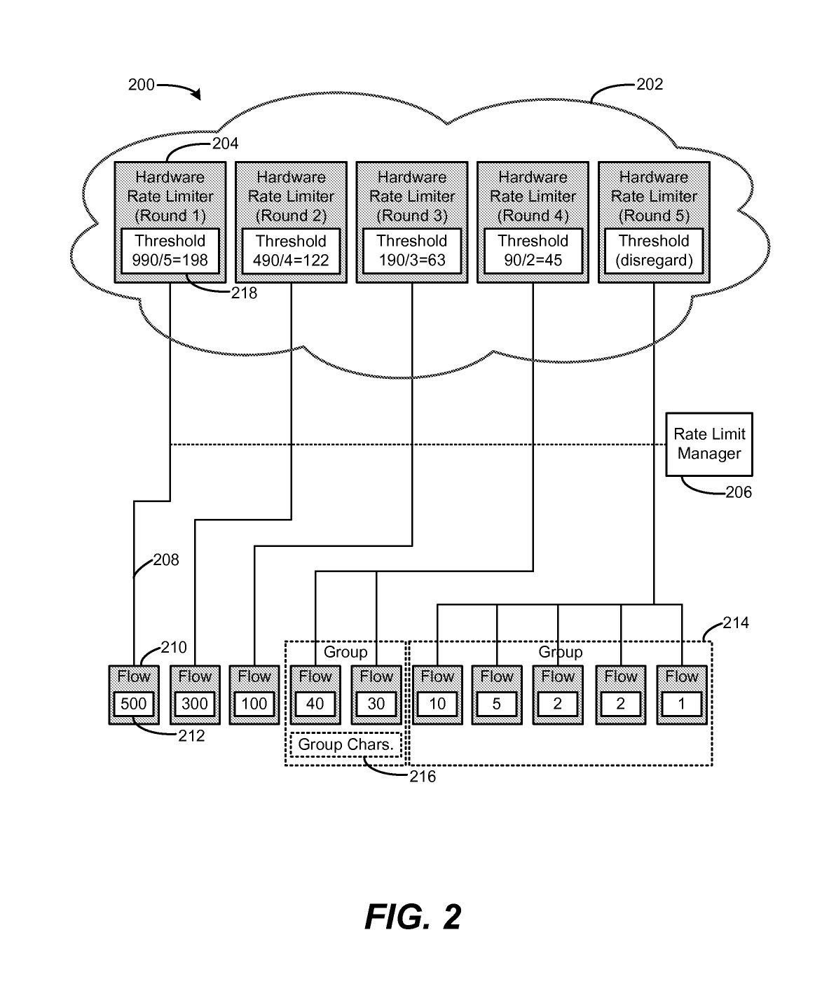

FIG. 2 is a block diagram of a system 200 including a rate limit manager 206 according to an example. The rate limit manager 206 may determine a threshold 218 for a hardware rate limiter 204 of network 202, and determine an assignment 208 between a hardware rate limiter 204 and a flow 210, based on the threshold 218. The flow 210 may include a rate limit value 212, and flows 210 may be assigned to a group 214. The group 214 may include various group characteristics 216.

For convenience, the flows 210 are shown arranged in order according to their rate limit values 212. However, the flows 210 may be disordered/unsorted. The flows 210 may be sorted in advance based on a sorting step, although sorting is not needed. For example, one approach may involve the rate limit manager 206 selecting flows 210 in rounds, based on which selection of flow(s) 210 has the greatest rate limit values 212 whose total just meets or exceeds the threshold 218 without having to add another flow 210. In some situations, there may be multiple selections that satisfy these criteria, and the rate limit manager 206 may choose which selection to employ based on other factors, as described below for example. The rate limit manager 206 may sort all of the flows 210 prior to selecting a flow 210 for assignment. Approaches may involve the rate limit manager 206 attempting to assign the flows 210 to the hardware rate limiters 204 based on the corresponding tenants who need hardware rate limiting the most (e.g., who need the fastest performance). Sorting may be used to prioritize flows 210, to enable mapping of corresponding tenants having similar rate limit values 212 to the same hardware rate limiters 204 (e.g., to the same group 214).

In an example technique for assigning flows 210 to hardware rate limiters 204, the rate limit manager 206 may identify a number of tenants/flows 210 to be assigned (f), each with an associated rate limit value 212 (v), and a number of available hardware rate limiters 204 (r). The rate limit manager 206 may determine whether r>=f, and if so, may assign each flow 210 to its own private hardware rate limiter 204. If r<f, the rate limit manager 206 may assign the flows 210 to the hardware rate limiters 204 based on forming at least one group 214. The assigning and/or grouping may be based on the rate limit values 212, and the rate limit manager 206 may sort the tenants/flows 210 in descending order according to their rate limit values 212 to facilitate identification of unassigned flows 210 corresponding to higher rate limit values 212 (although such identification may be performed without a need to sort the tenants/flows 210).

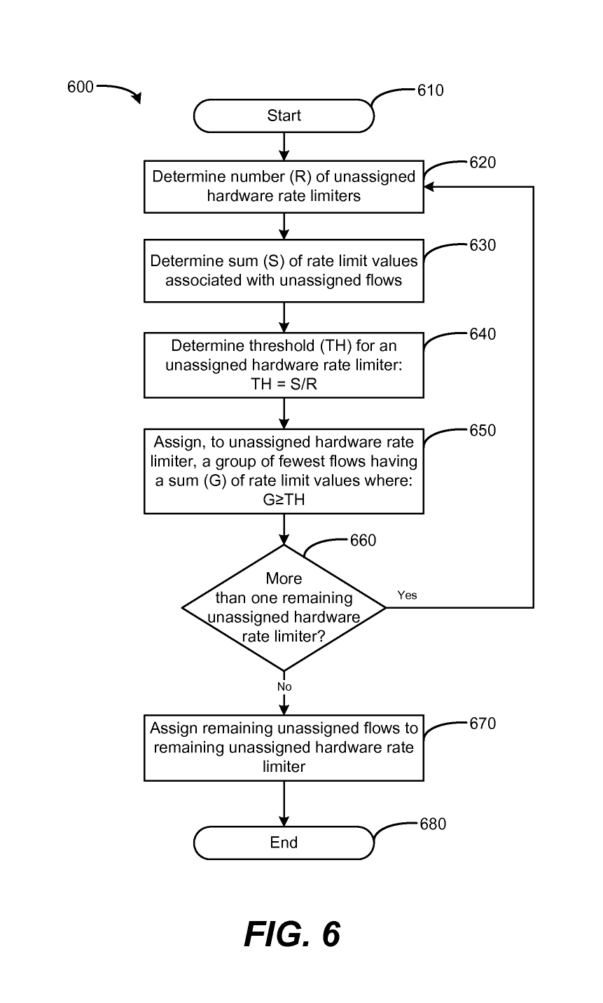

If there is more than one remaining available/unassigned hardware rate limiter 204, the rate limit manager 206 may compute a threshold value 218 for an unassigned hardware rate limiter 204. In an example, the threshold 218 (th) for an unassigned hardware rate limiter 204 may be determined as a sum of the rate limit values 212 (v) of unassigned tenants/flows 210 (Σv for f_{unassigned}), divided by the number of remaining unassigned hardware rate limiters 204 (r_{unassigned}) such that th=(Σv)/(rᵤ). The rate limit manager 206 may group the first fewest set of tenants/flows 210 whose combined sum of rate limit values 212 exceeds the threshold value 218, and assign them to a hardware rate limiter 204 for that threshold. The first fewest may correspond to a sorted set of flows 210 by choosing the highest sorted value and proceeding by taking the next flow 210 in descending order. If not sorted, the first fewest may correspond to the smallest number of flows 210 that may be chosen to meet or exceed the threshold, typically those having the highest rate limit values 212 among unassigned flows 210. When a single unassigned hardware rate limiter 204 remains, the rate limit manager 206 may assign all remaining tenants/flows 210 to that hardware rate limiter 204, without needing to determine a threshold 218 for that last hardware rate limiter 204. A flowchart showing such a technique may be seen in FIG. 6, for example.

The example technique of FIG. 6 also may be applied to FIG. 2. FIG. 2 shows five hardware rate limiters 204 (r=5), and ten tenants/flows 210 (f=10) with the following rate limit values 212: v=(500, 300, 100, 40, 30, 10, 5, 2, 2, 1). Because f exceeds r, there are not enough hardware rate limiters 204 to assign a unique hardware rate limiter 204 to each tenant/flow 210. The rate limit manager 206 may assign the flows 210 to the hardware rate limiters 204 in five rounds (one round per hardware rate limiter 204) as follows. Round 1: threshold (th)=(Σv)/(rᵤ)=(500+300+100+40+30+10+5+2+2+1)/5=990/5=198. Because the rate limit value 212 of the first flow 210 (v=500) is greater than th=198, the first flow 210 is assigned by the rate limit manager 206 to its own hardware rate limiter 204. Round 2: The next threshold is determined, excluding the now assigned flow 210 and hardware rate limiter 204, as follows: threshold=(300+100+40+30+10+5+2+2+1)/4=490/4=122.5. Because the rate limit value 212 of the next highest flow 210 (v=300) is greater than th=122.5, the second tenant/flow 210 gets its own hardware rate limiter 204. Round 3: threshold=(100+40+30+10+5+2+2+1)/3=190/3=63.33. The third tenant/flow 210 is assigned its own private rate limiter 204 because its rate limit value 212 (v=100) exceeds th=63.33. Round 4: threshold=(40+30+10+5+2+2+1)/2=90/2=45. The next highest remaining flow 210 has a rate limit value 212 of 40, which does not exceed the threshold 218 of the =45. Thus, the fourth and fifth flows 210 together ((40+30)>45) are to share the next available (fourth) hardware rate limiter 204, such that the combined total of their rate limit values 212 is to exceed the threshold 218 of the fourth hardware rate limiter 204, using the fewest number of next tenants/flows 210. Round 5: because only one hardware rate limiter 204 remains unassigned in round five, the remaining unassigned five tenants/flows 210 are assigned to the fifth (last remaining) hardware rate limiter 204, independent of the threshold. Thus, when the rate limit manager 206 determines that there is one remaining unassigned hardware rate limiter 204, the rate limit manager 206 does not need to even determine its threshold, because it would be disregarded so that remaining unassigned flows 210 may be assigned.

The tenants/flows 210 having the five smallest rate limit values 212 (10, 5, 2, 2, and 1 kbps) are grouped and assigned to one hardware rate limiter 204. The rate limit manager 206 may direct the hardware rate limiter 204 to provide, for this group 214, 50 kbps of network bandwidth for the entire group 214. That amount may be determined by the rate limit manager 206 to ensure that, if all tenants/flows 210 attempt to use the bandwidth of the hardware rate limiter 204, no flow will fall below 10 kbps, which is the guarantee for the highest ranked flow 210 of the group 214. In other words, the rate limit manager 206 may determine the group limit based on the five tenants/flows 210 of the group 214, multiplied by the highest rate limit value 212 of all those five tenants/flows 210 (which is 10 kbps). Thus, by providing 50 kbps available to all these five tenants/flows 210, the rate limit manager 206 may guarantee that even if the flows 210 compete for bandwidth in the group 214 assigned to the fifth hardware rate limiter 204, each flow 210 will get at least its guaranteed rate.

The rate limit manager 206 may direct the hardware rate limiter 204 to ensure that the total bandwidth available at a hardware rate limiter 204 is greater than the total (sum) of the individual rate limit values 212 of flows 210 grouped onto that hardware rate limiter 204. Thus, the rate limit manager 206 may not assign additional flows 210 to a hardware rate limiter 204, if that addition would cause the total of rate limit values 212 for the group 214 to exceed the total bandwidth available at the hardware rate limiter 204. Thus, the rate limit manager 206 may ensure that tenants/flows 210 are provided their guaranteed bandwidth, by intelligently grouping the flows 210 together regardless of specific technique used and in view of the overall conditions beyond a given flow 210.

The group 214 may include group characteristics 216. The group characteristics 216 may be used to provide guarantees for each of the flows 210, for example. Group characteristics 216 may include type of network protocol, associated tenant, rate limit demands, and other aspects (e.g., flow descriptors/parameters) related to the flows 210 in the group 214. Generally, if assigning a single tenant/flow 210 to a hardware rate limiter 204, that flow's bandwidth may be protected without worrying about other tenants consuming some of the available bandwidth of the hardware rate limiter 204. However, with multiple tenants/flows 210 assigned to the same hardware rate limiter 204, network limitation mechanisms (e.g., limitation mechanisms associated with network protocols such as transmission control protocol (TCP), user datagram protocol (UDP), and so on) may be used to affect relative bandwidth consumption between flows 210 assigned to that hardware rate limiter 204. However, a tenant may attempt to cheat and take additional bandwidth for its corresponding flow 210, to the detriment of other flows 210 on that hardware rate limiter 204. This risk may increase as the number of tenants/flows assigned to a hardware rate limiter 204 (e.g., the last remaining hardware rate limiter 204) increases.

Thus, the rate limit manager 206 may consider the rate limit values 212 for a group 214, and other group characteristics 216, to provide techniques to enable each tenant/flow 210 to enjoy its full bandwidth guarantee. In an example, if a total of the rate limit values 212 for a group 214 is 900 Mbps, and a hardware rate limiter 204 provides a network link of 1000 Mbps (1 Gbps), the rate limit manager 206 may use the extra remaining bandwidth as a cushion for the group 214 as-needed for each member/flow 210. In another example, instead of assigning a total rate limit for the hardware rate limiter 204 that is equal to the sum of the individual rate limit values 212 of the group, the rate limit manager 206 instead may assign a total rate limit equal to the number of tenants/flows 210 in the group 214, multiplied by the maximum rate limit value 212 among the tenants/flows 210 in that group 214. For example, with three tenants/flows 210 having rate limit values 212 of (2, 2, 1), their total of rate limit values 212 is 2+2+1=5. However, instead of assigning a total rate limit of 5 on that group of three flows 210, the rate limit manager 206 instead may assign a total rate limit of 6 to that group. Thus, each flow would be guaranteed the maximum limit of their bandwidth (e.g., 2), even if all three divide the total (6) equally among themselves according to flow fairness or other protocol features. The rate limit manager 206 may provide an opportunity for a fair allocation of the bandwidth for a hardware rate limiter 204.

In another example, the rate limit manager 206 may determine at what point a rate limit is applied along the network path of the network 202 (e.g., the rate limit may be applied just as network packets are about to leave a physical switch or other component of the network 202). Thus, depending on where the rate limiting is performed in the physical hardware of network 202, the rate limit manager 206 may apply different types of rate limiting approaches. For example, if rate limiting is being applied approximately when a packet is being sent out from a network component, then at that point, rate limiting may be applied on a per-port basis, in contrast to being applied across the network component. Thus, in some situations, the rate limit manager 206 may provide network limit restrictions on a per-port basis, and in some situations, may apply the limits across the entire network component. The rate limit manager 206 may identify at what time/point the rate limiting is to be applied, along the stages of network processing of a packet in a switch or other network component.

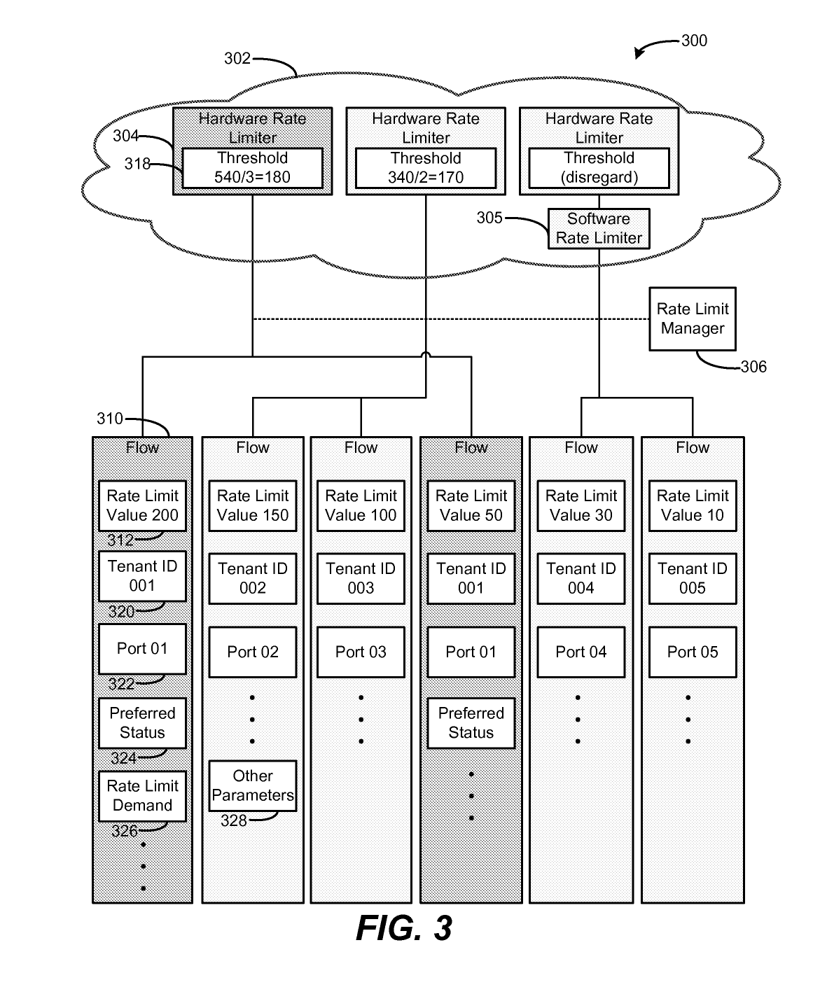

FIG. 3 is a block diagram of a system 300 including a rate limit manager 306 according to an example. The rate limit manager 306 may determine a threshold 318 for a hardware rate limiter 304 of a network 302, and assign a flow 310 to a hardware rate limiter 304, based on the threshold 318. A software rate limiter 305 also may be involved. A flow 310 may be associated with various group characteristics, including rate limit value 312, tenant ID 320, port 322, status 324, rate limit demand 326, and other parameters 328.

The rate limit manager 306 may determine assignments based on, e.g., taking as input the rate limit values 312 assigned to each tenant/flow 310, i.e., F→R, where F is the set of flows 310 and R is the set of rate limit values 312. The range of inputs for the rate limit manager 306 may be extended to include rate limit values 312 for each flow 310 per port 322 (or other parameters/descriptors), i.e., F×P→R, where P is the set of ports 322. The rate limit manager 306 may merge flows 310 into groups, e.g., based on a restriction. Thus, in an example, a restriction may prevent merging flows 310 into groups where their rate limit values 312 involve different ports 322 (or other descriptor). FIG. 3 shows two flows 310 in gray, merged into a group based on the port 322 having a value of 01 (and/or also based on the indication of preferred status 324 or tenant ID 320). Accordingly, the port 322 may be used to assign hardware rate limiters 304 (e.g., part of a switch of the network 302) on a per link basis. Thus, in an example network switch having 32 ports available, the available hardware rate limiters 304 may be assigned among the ports of the switch to enforce per port rate limits.

The six flows 310 shown in FIG. 3 are assigned to three hardware rate limiters 304 according to three groups of two flows 310 each. As shown, each hardware rate limiter 304 includes a threshold 318 (except in the last remaining hardware rate limiter 304 where the threshold 318 is disregarded). However, the first and fourth flows 310 are assigned to the first hardware rate limiter 304, even though its threshold would typically suggest assigning only the first flow 310 whose rate limit value 312 alone (v=200) exceeds the threshold 318 of the first hardware rate limiter 304 (th=180). Thus, the rate limit manager 306 has considered factors other than the rate limit value 312 when determining how to group and/or assign the flows 310.

In an example, the plurality of flows 310 are to interact with a plurality of output ports 322, which may be, e.g., physical hardware ports on a network device/switch/network 302. For each flow/port combination possible, the rate limit manager 306 may identify a rate limit value 312 (e.g., the rate limit value 312 for a given flow 310 may be different, depending on the port 322 used). A first rate limit value 312 may be associated with a first flow 310 going onto a first port 322. A second (possibly different) rate limit value 312 may be associated with that first flow 310 going into a second port 322, and so on for all combinations of flows 310 and ports 322. Thus, the rate limit manager 306 may apply a technique similar to that described above for assigning flows 310 to hardware rate limiters 304, except that the input would expand to a group of tuples (flow×port) and their associated rate limit values. The technique may involve the rate limit manager 306 selecting the next fewest tuples having the highest rate limit value(s) 312, and assigning it/them to the next available/unassigned hardware rate limiter 304 (e.g., in satisfaction of the determined threshold 318 for that available hardware rate limiter 304). A tuple may be formed based on other combinations of descriptors of a flow 310, such as any combination that is identifiable and that may be associated with a rate limit value 312. Some combinations to form tuples may be restricted, due to configuration, preference, or hardware limitations. Such restrictions also may be associated with limitations of a particular hardware rate limiter 304 (e.g., preventing two flows associated with different ports from being assigned to the same hardware rate limiter 304, and so on), although examples (and/or hardware) may enable such assignments/tuples regardless of hardware limitations. Thus, depending on the type of hardware capabilities available, the rate limit manager 306 may employ different techniques/approaches to creating tuples for grouping onto the different hardware rate limiters 304.

Descriptors for a flow 310 may be found in a header associated with the flow 310. An example packet header pattern for a flow 310 may be: “IP address source=10.0.0.2, IP address destination=10.0.0.3, protocol=TCP, destination port=80.” Such a header pattern may denote a hypertext transfer protocol (HTTP) flow from host 10.0.0.2 to host 10.0.0.3. The rate limit manager 306 (e.g., a central controller) may direct a hardware rate limiter 304 (e.g., the network switch) to limit this flow 310 to 10 Mbps, for example. The rate limit manager 306 may limit, group, assign, and/or otherwise classify the flow 310 according to such information by examining a header of a packet of a flow 310. Additionally, the rate limit manager 306 may infer characteristics to be used for assigning the flow 310, and may consider other aspects of the flow 310, including data or other contents of the packet and/or flow 310. For example, the rate limit manager 306 may infer the port 322 of a flow 310, based on the IP address destination of the header from a packet of the flow 310. Thus, the rate limit manager 306 may provide multiple such flow definitions/descriptors and rate limit values 312 associated with those flows 310. The network 302 (e.g., via hardware rate limiter 304, network switch, and so on) may implement the rate limit values 312 by assigning them among the hardware rate limiters 304 available to be assigned.

The rate limit manager 306 may assign/group flows 310 according to a status 324. For example, a flow 310 may be given a preferred status 324 (e.g., based on the flow 310 being from a preferred tenant, such as marking a preferred status 324 on all flows 310 to/from that tenant). Thus, the flows 310 may be sorted (or selected/assigned/group in an order) according to the status 324, which may be a hierarchical value (e.g., bronze, silver, gold, platinum, etc.). For example, a flow 310 having a “platinum” preferred status 324 may be assigned to its own hardware rate limiter 304, without needing to share with other tenants/flows 310. In contrast, a bronze status 324 may indicate that the flow 310 is to share with a large number of other bronze status flows 310. The rate limit manager 306 may further create a tuple based on the preferred status 324 and other descriptors such as the rate limit value 312, thereby applying a technique for assigning/grouping the flows 310 based on more than just the preferred status 324.

The rate limit manager 306 may consider characteristics of a given group, and then assign a flow 310 to that group in view of the group characteristics. For example, the rate limit manager 306 may consider the maximum rate limit value 312 among flow(s) of a group, and attempt to minimize a maximum difference between 1) the rate limit value 312 of a flow 310 to be assigned to that group, and 2) the maximum rate limit value 312 for the group. To minimize/maximize, the rate limit manager 306 may consider all possible combinations/candidates and choose the optimal candidate in view of those finite, determinant combinations. The rate limit manager 306 may consider other aspects, including taking a ratio of a difference between the mean and/or maximum values of a group, in contrast to simply considering the absolute difference. Such optimization criteria may enable the rate limit manager 306 to provide groups of flows 310 to fully optimize the performance of the hardware rate limiter 304 without impacting the level of network performance of the flows 310.

The rate limit manager 306 may implement restrictions that affect how flows are to be grouped and/or assigned. An example restriction would be to avoid assigning, to a group, flows 310 that go to different output ports 322. A restriction may or may not be necessary (e.g., may be a preference without being absolute), and may depend on how a hardware rate limiter 304 (i.e., the network switch hardware) is constructed. The restrictions may be weighted and/or optional, in determining how the flows 310 are to be formed in groups to be assigned to hardware rate limiters 304. Other restrictions/criteria may include fine-tuning, such as HTTP flows belonging to a particular tenant and limiting those to 10 Mbps. Or, for example, identifying packets of a tenant going from a particular IP address to another particular IP address and limiting those packets to 2 Mbps, and so on.

The rate limit manager 306 may interpret various aspects of the flow 310. For example, a packet header of a flow 310 may include tenant ID 320, depending on the type of packet header for that particular protocol. In some networking protocols (e.g., a datacenter protocol), every packet may carry some type of identifier, including an identifier to denote a tenant or other aspect of the flow 310. Thus, rate limit manager 306 may direct a switch to look at the packet header and determine to which tenant that packet belongs. A flow 310 may be defined by a pattern that is in its packet headers.

Example systems 300 may interact with a virtual machine (VM). In an example, a network switch may interface with a host machine, on which a tenant's VM is to run. That VM may be in communication with other VMs that are located elsewhere. When packets from the host machine reach the network switch, the packets may be sent in multiple flows 310 (e.g., one flow 310 per VM). The multiple flows 310 from the host machine may have the same tenant identifier 320 (e.g., based on their origin), but they may be routed to different output ports of the network switch, because the flows 310 are to go to different other machines. Based on the destination of the flows 310, they may get routed to different ports. In that sense, the rate limit manager 306 may use a packet's destination address and its tenant identifier 320 to determine on which output port the packet is to go. In the case of rate limiting, the output port information (to which output port a packet is going) may be used in determining the rate limit value 312. Thus, the rate limit manager 306 may enforce different rate limits for different ports, and may consider different usage scenarios in the enforcement, even taking into account whether VMs are involved and which physical attributes are implicated in addition to the VM attributes.

In an example, for a tenant sending traffic on output port 1, the rate limit manager 306 may limit that traffic to 100 Mbps. However, for traffic going on output port 2, the rate limit manager 306 may allow a limit of 200 Mbps from that port (e.g., port 2 receives much fewer usage/traffic overall, so fewer limitations are placed on its usage due to less competition for its resources among tenants). Thus, the rate limit manager 306 may determine that a port 1 link is popular or otherwise shared by a lot of tenants, and therefore place greater limitations on its use. The rate limit manager 306 may identify a rarely used port and enforce almost no limit for it. The rate limit manager 306 has flexibility to customize limits per port, in consideration of the amount of usage of that port (e.g., usage by others and/or its general congestion/popularity). Thus, the rate limit manager 306 may use various inputs in its technique for assigning flows 310 to hardware rate limiters 304, not only a flow descriptor/parameter and rate limit value 312, but also factors external to the flow 310 itself.

System 300 may involve a software rate limiter 305. The software rate limiter 305 may augment the hardware rate limiters 304, e.g., provide a bridge between software and hardware. System 300 may utilize a software/hardware hybrid setup, that may avoid using software rate limiter 305 for the fastest tenants/flows. This aspect is illustrated by the software rate limiter 305 being used to augment the third hardware rate limiter 304 corresponding to the two flows 310 having the lowest rate limit values 312 (e.g., the lowest-ranked group/flows 310, assigned by disregarding the threshold 318). Example systems 300 may enable use of native execution of an operating system directly on the hardware with no hypervisor needed, and may enable a mix of hypervisor and native execution, and even using a hypervisor based on hardware rate limiters 304 without use of a software rate limiter 305.

The rate limit manager 306 may use software rate limiter 305 to enforce fairness among multiple tenants/flows 310 sharing the same hardware rate limiter 304. Different tenants may attempt to interfere with each other (e.g., “cheat” to obtain more networking resources relative to other tenants assigned to a hardware rate limiter 304). If different tenants run different protocols (e.g., one tenant running TCP and one running UDP) on the same hardware rate limiter 304, the different protocols may react differently to protocol-based fairness techniques. Thus, a software rate limiter 305 may be used to enforce rate limits for the tenants that are sharing the hardware rate limiter 304. For example, a system 300 may additionally provide software rate limiters 305 at the end host. Additional guarantees may be enforced by isolating certain (e.g., high-value) tenants away from low-value tenants, and giving the high-value tenants hardware rate limiters 304 having guarantees that would not be affected by low-value tenants.

Example systems 300 provide various benefits that may avoid the detriments of providing rate limiting at the end host (e.g., software-based rate limiting). Detriments avoided may include avoiding a need for software modifications at the end host, such as a need for a virtual hypervisor, and avoiding consuming processor cycles in the end host due to such software (resources that would otherwise be sold to customers). A customer may want to use native execution and not be forced to use the hypervisor, to be able to connect a non-virtualized computer to the network, which may cause rate limiting difficulties if hardware rate limiting is not provided. Furthermore, accurate rate limiting in the end host software becomes particularly difficult, especially at higher bandwidths, compared to rate limiting in the switch hardware (i.e., using hardware rate limiters 304). Thus, example systems 300 enable flexibility based on hardware rate limiting, while avoiding detriments of software rate limiting. Hardware approaches may be combined with software augmentation, to provide some policing at the end host. By selectively applying the software augmentation (e.g., software rate limiter 305 for the lower rate tenants), far fewer resources may be devoted to the end host or the hypervisor. Using hardware rate limiters 304 (and/or other network/hardware resources, such as rate limiters in network interface cards (NICs) controlled by feedback in switches), a bulk of the load is not carried by software rate limiting, and therefore processor resource needs are reduced tremendously without giving up limiting accuracy.

The rate limit manager 306 may determine assignments based on rate limit demand 326. The rate limit manager 306 may consider the present demand (e.g., either measured or estimated) of each flow 310, and use that information in the grouping/assigning of the flows 310. For example, the rate limit manager 306 may group together flows 310 that have similar rate limit values 312, and have similar (or higher) rate limit demands 326, rather than simply grouping flows 310 having similar rate limits despite whether they may have different rate limit demands 326. For example, given two flows 310, one has a rate limit value 312 of 100, and the other has a rate limit value of 50. Both of those flows 310 may have a rate limit demand 326 of 50. The rate limit manager 306 may group these two flows 310 together because the demand is equal, despite the difference in rate limit values 312. The total rate limit for a hardware rate limiter 304 may be set based on the rate limit demand 326, e.g., for the example flows above, the total rate limit may be set to 100 (demands of 50+50), instead of 150 as would be suggested by the rate limit values (50+100). The rate limit demand 326 may be used to further determine the next flow 310 to be assigned to a group. In an example, if a group of flows 310 are very close in rate limit values 312 to each other, the rate limit demand 326 may be used to determine which flow is next highest. The rate limit demand 326 may be used as a secondary metric to determine which flows to be combined into a group.

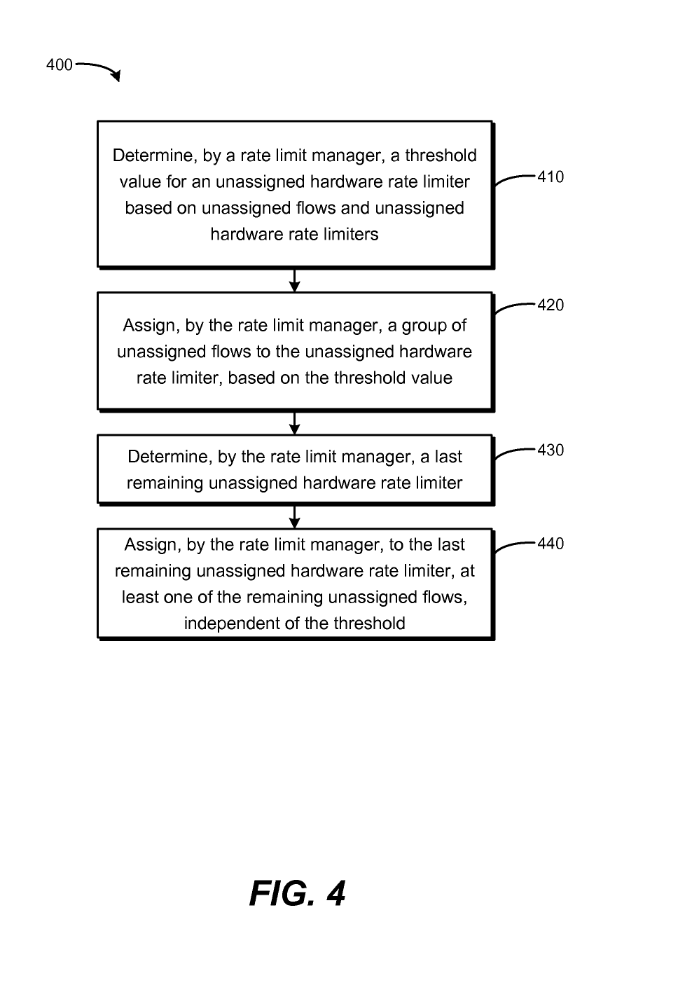

FIG. 4 is a flow chart 400 based on assigning flows according to an example. In block 410, a threshold value for an unassigned hardware rate limiter is determined, by a rate limit manager, based on unassigned flows and unassigned hardware rate limiters. In an example, the rate limit manager may take the total rate limit values among unassigned flows, and divide that total by the number of available hardware rate limiters. That threshold may be used for the hardware rate limiter to be assigned. In block 420, a group of unassigned flows are assigned, by the rate limit manager, to the unassigned hardware rate limiter, based on the threshold value. In an example, the rate limit manager may take flows in descending order of rate limit values, and accumulate a group of flows until their total rate limit values meets or exceeds the threshold. In block 430, a last remaining unassigned hardware rate limiter is determined, by the rate limit manager. For example, the rate limit manager determines if one last hardware rate limiter remains, before making further determinations and/or calculations. In block 440, at least one of the remaining unassigned flows is assigned, by the rate limit manager, to the last remaining unassigned hardware rate limiter, independent of the threshold. In an example, the rate limit manager assigns all remaining unassigned flows to that hardware rate limiter without needing to determine a threshold. The flows are assigned, even if their total would have exceeded the threshold of that hardware rate limiter without using all of those flows (assuming the threshold was even determined, which may be the case in some examples).

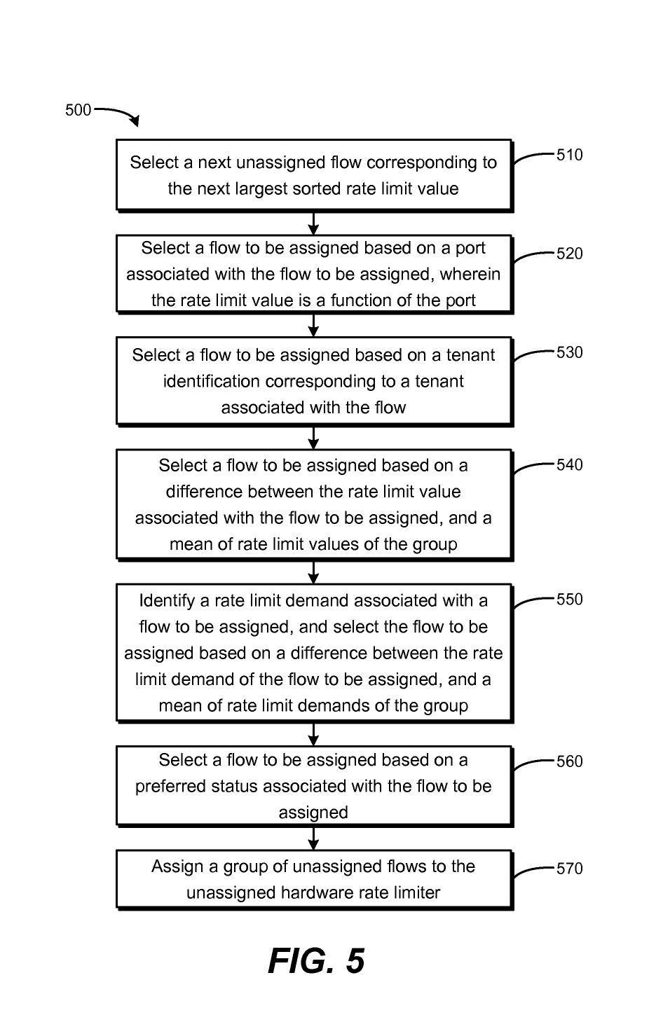

FIG. 5 is a flow chart 500 based on selecting flows to be assigned according to an example. In block 510, a next unassigned flow corresponding to the next largest sorted rate limit value is selected. In an example, the flows may be unsorted and a largest rate limit value may be identified and selected. In block 520, a flow to be assigned is selected based on a port associated with the flow to be assigned, wherein the rate limit value is a function of the port. For example, a port with low congestion may receive a higher rate limit value, and a port with high congestion may receive a lower rate limit value. The rate limit manager may determine factors external to the port itself, such as previous usage patterns and tenant composition, in determining the rate limit for a port. In block 530, a flow to be assigned is selected based on a tenant identification corresponding to a tenant associated with the flow. For example, the rate limit manager may consider various features (e.g., header, descriptors) to infer the tenant associated with that flow, and impose limits to the flow according to the corresponding tenant. In block 540, a flow to be assigned is selected based on a difference between the rate limit value associated with the flow to be assigned, and a mean of rate limit values of the group. Thus, the rate limit manager may determine features of a group as it is being formed, and determine whether to modify that group. In block 550, a rate limit demand associated with a flow to be assigned is identified, and the flow to be assigned is selected based on a difference between the rate limit demand of the flow to be assigned, and a mean of rate limit demands of the group. Thus, the rate limit manager may assign flows based on actual or estimated demands. In block 560, a flow to be assigned is selected based on a preferred status associated with the flow to be assigned. For example, a flow may correspond to a tenant with preferred status, such that the flow is provided with resources of a hardware rate limiter that may not correlate directly with the rate limit value of that flow. In block 570, a group of unassigned flows is assigned to the unassigned hardware rate limiter. Thus, the group may be based on factors that are not directly related to the flow itself, or its rate limit value, and may be based on extrinsic factors or intrinsic factors of the flow (e.g., flow descriptors, headers, etc.).

FIG. 6 is a flow chart 600 based on assigning flows according to an example. The flow chart starts in block 610. In block 620, a number (R) of unassigned hardware rate limiters is determined. In block 630, a sum (S) of rate limit values associated with unassigned flows is determined. In block 640, a threshold (TH) for an unassigned hardware rate limiter is determined: TH=S/R. In block 650, a group of fewest flows having a sum (G) of rate limit values are assigned to an unassigned hardware rate limiter, where: G≧TH. In an example, the flows may be sorted according to their rate limit values and other metrics (e.g., rate limit demand). In an alternate example, the flows are unsorted. In block 660, it is determined whether there is more than one remaining unassigned hardware rate limiter. If yes, flow proceeds to repeat blocks 620-660. If there is not more than one remaining unassigned hardware rate limiter, flow proceeds to block 670. In block 670, remaining unassigned flows are assigned to the remaining unassigned hardware rate limiter. For example, the flows may be assigned regardless of any threshold, and without calculating a threshold. Flow ends at block 680.

Those of skill in the art would appreciate that the various illustrative components, modules, and blocks described in connection with the examples disclosed herein may be implemented as electronic hardware, computer software, or combinations of both. Thus, the example blocks of FIGS. 1-6 may be implemented using software modules, hardware modules or components, or a combination of software and hardware modules or components. In another example, one or more of the blocks of FIGS. 1-6 may comprise software code stored on a computer readable storage medium, which is executable by a processor. As used herein, the indefinite articles “a” and/or “an” can indicate one or more than one of the named object. Thus, for example, “a processor” can include one or more than one processor, such as in a multi-core processor, cluster, or parallel processing arrangement. The processor may be any combination of hardware and software that executes or interprets instructions, data transactions, codes, or signals. For example, the processor may be a microprocessor, an Application-Specific Integrated Circuit (“ASIC”), a distributed processor such as a cluster or network of processors or computing device, or a virtual machine. The processor may be coupled to memory resources, such as, for example, volatile and/or non-volatile memory for executing instructions stored in a tangible non-transitory medium. The non-transitory machine-readable storage medium can include volatile and/or non-volatile memory such as a random access memory (“RAM”), magnetic memory such as a hard disk, floppy disk, and/or tape memory, a solid state drive (“SSD”), flash memory, phase change memory, and so on. The computer-readable medium may have computer-readable instructions stored thereon that are executed by the processor to cause a system (e.g., a rate limit manager to direct hardware rate limiters) to implement the various examples according to the present disclosure.

What is claimed is:

1. A system comprising:
a rate limit manager to assign a plurality of network traffic flows to a plurality of hardware rate limiters, wherein the plurality of hardware rate limiters is to enforce rate limits of a plurality of network traffic flows, wherein each of the plurality of network traffic flows is associated with a corresponding rate limit value;
wherein the rate limit manager is to determine, for an unassigned one of the plurality of hardware rate limiters, a threshold value; and to assign a group of at least one of the plurality of flows to the unassigned hardware rate limiter based on the threshold value;
wherein the rate limit manager is to assign, to a last remaining unassigned hardware rate limiter, at least one of the remaining unassigned flows, independent of the threshold value.

2. The system of claim 1, wherein the threshold value is based on a sum of rate limit values from unassigned flows divided by a number of unassigned hardware rate limiters.

3. The system of claim 1, wherein the group is based on a fewest number of at least one of the plurality of flows whose sum of at least one of the plurality of corresponding rate limit values is to meet or exceed the threshold

4. The system of claim 1, wherein the rate limit manager is to direct the hardware rate limiter to enforce a shared rate limit for its assigned flows, based on a product of the number of its assigned flows and a highest rate limit value among the assigned flows.

5. The system of claim 1, wherein the threshold value is based on a function of at least one of rate limit demand, port, tenant identification, and preferred status associated with the flows.

6. A method of assigning a plurality of network traffic flows to a plurality of hardware rate limiters, comprising:
determining, by a rate limit manager, a threshold value for an unassigned hardware rate limiter based on unassigned flows and unassigned hardware rate limiters;
assigning, by the rate limit manager, a group of unassigned flows to the unassigned hardware rate limiter, based on the threshold value;
determining, by the rate limit manager, a last remaining unassigned hardware rate limiter; and
assigning, by the rate limit manager, to the last remaining unassigned hardware rate limiter, at least one of the remaining unassigned flows, independent of the threshold.

7. The method of claim 6, wherein the plurality of network traffic flows are associated with corresponding respective rate limit values, the method further comprising sorting the unassigned flows based on their corresponding respective rate limit values, and determining the group based on including a next unassigned flow corresponding to the next largest sorted rate limit value.

8. The method of claim 6, wherein the plurality of network traffic flows are associated with corresponding respective rate limit demands, the method further comprising sorting the unassigned flows based on their corresponding respective rate limit demands, and determining the group based on including a next unassigned flow corresponding to the next largest sorted rate limit demand.

9. The method of claim 6, wherein determining the group of unassigned flows to be assigned includes selecting a flow to be assigned based on a tenant identification corresponding to a tenant associated with the flow.

10. The method of claim 6, wherein determining the group of unassigned flows to be assigned includes selecting a flow to be assigned based on a difference between the rate limit value associated with the flow to be assigned, and a mean of rate limit values of the group.

11. The method of claim 6, wherein determining the group of unassigned flows to be assigned includes identifying a rate limit demand associated with a flow to be assigned, and selecting the flow to be assigned based on a difference between the rate limit demand of the flow to be assigned, and a mean of rate limit demands of the group.

12. The method of claim 6, wherein determining the group of unassigned flows to be assigned includes selecting a flow to be assigned based on a preferred status associated with the flow to be assigned.

13. The method of claim 6, wherein determining the group of unassigned flows to be assigned includes selecting a flow to be assigned based on a port associated with the flow to be assigned, wherein the rate limit value is a function of the port.

14. A non-transitory machine-readable storage medium encoded with instructions that if executed cause a system to:
determine, for an unassigned hardware rate limiter, a threshold value associated with an unassigned plurality of network traffic flows;
sort the unassigned flows according to their respective associated rate limit values;
determine, by a rate limit manager, a group of unassigned flows to be assigned to the unassigned hardware rate limiter, based on the unassigned flows taken in sorted order; and
assign the group to the unassigned hardware rate limiter.

15. The storage medium of claim 14, further comprising instructions that cause the system to determine the threshold value based on a sum of rate limit values for unassigned flows divided by a number of unassigned hardware rate limiters, and determine the group to be assigned based on the unassigned flows whose sum of at least one of the plurality of corresponding rate limit values is to meet or exceed the threshold.
